(19) United States
(12) Patent Application Publication
(10) Pub. No.: US 2011/0213661 A1
(43) Pub. Date: Sep. 1, 2011

(54) Computer-Implemented Method For Enhancing Product Sales

(76) Inventors: Joseph Milana, San Diego, CA (US); Bo Zhang, San Diego, CA (US)

(21) Appl. No.: 12/715,302

(22) Filed: Mar. 1, 2010

(51) Int. Cl. G06Q 30/00; G06Q 10/00; G06N 5/02

(52) U.S. Cl. 705/14.52; 705/14.53; 706/52

(57) ABSTRACT

A computer-implemented method for providing product recommendations to customers is disclosed. For each customer for whom a product recommendation is desired, hereinafter “the target customer”, a group of other customers, hereinafter “a group of nearest neighbors” is identified using an algorithm that examines each customer's previous spending across a plurality of different product categories and optionally, one or more demographic attributes, and then selects those customers whose attributes most nearly matches that of the target customer. The products purchased by these nearest neighbors that have not been purchased by the target customer are then ranked using a ranking algorithm that weights such purchased products based on the frequency of their purchase and the number of nearest neighbors purchasing such products. A product recommendation for the target customer is formed by selecting a predetermined number of the highest ranked products purchased by the nearest neighbors.

### CROSS REFERENCE TO RELATED APPLICATIONS

This patent relates to co-filed patent application Ser. No. ______, entitled COMPUTER-IMPLEMENTED METHOD FOR ENHANCING TARGETED PRODUCT SALES and is incorporated by reference herein.

### FIELD OF THE INVENTION

The present invention relates to a computer-implemented marketing method for enhancing the sales of products and/or services and, more particularly, to a method that recommends particular products and/or services for a customer that have not been previously purchased by that customer but which have been purchased by other customers determined to be similar to that customer.

### BACKGROUND OF THE INVENTION

Businesses today are under ever-increasing pressures to increase product sales and enhance profitability. A variety of techniques, such as product promotions, discounts, coupon offering and the like have long been used to promote product sales. While such techniques have proved beneficial, such techniques tend to increase the sales of those products being promoted with minimum effect on other products not being promoted. Also, there are costs associated with such promotions, such as providing and distributing product coupons, advertisements and the like. In addition, the promotions tend to be applied across a broad segments of a customer base and are not tailored to any particular customer.

Finally, such techniques tend to increase the sales of promoted products to customers that are already purchasing such products and have lesser impact on other products. It has long been considered desirable to develop and implement a computer based method that would identify those specific products that have not been previously purchased by a customer but are nevertheless predicted to be desired by that customer, if properly presented. To this end, such product promotions would be individually tailored for each customer and would not entail the costs associated with prior art product promotions.

### SUMMARY OF THE INVENTION

The present invention overcomes the limitations of the prior art by providing an improved computer implemented method that processes existing customer data to provide specific product recommendations for customers. Each product recommendation is directed to a particular customer, hereinafter “the target customer”, and recommends one or more products that have not been purchased by the target customer but have been purchased by other customers determined by the improved method to be similar to the target customer. Pursuant to the present invention, customer data comprising previous product purchases is examined to identify those other customer(s) that possess similar characteristics or attributes to a target customer. For ease of explanation, such other identified similar customers shall be hereinafter referred to as “the nearest neighbors”. The products purchased by such nearest neighbors are then examined to identify those purchased products that have not been purchased by the target customer for determining a specific product recommendation for the target customer. In accordance with an embodiment of the invention, the identified products are ranked to select a product recommendation for the target customer based on one or more of the higher ranked products.

In accordance with a representative embodiment of the present invention, the nearest neighbors for any target customer is identified by forming a signature vector for each customer. The signature vector for each customer has a predetermined number of dimensions, wherein each dimensions represents different product categories and the magnitude of any vector dimension corresponds to the percentage of dollars spent by the customer in the product category associated with that vector dimension. Optionally, the vector may also include one or more dimensions associated with behavioral or demographic attributes of the customer. The cosine measure of each target customer's signature vector and the signature vector of all other customers is then formed to identify the target customer's nearest neighbors. The products purchased by these nearest neighbors that have not been purchased by the target customer are then ranked and the product recommendation for the target customer is one or more of the highest ranked products. Advantageously, the disclosed technique is particularly suitable for use in “door-to-door” product sales.

### BRIEF DESCRIPTION OF THE DRAWINGS

For a better understanding of the present invention, reference is made to the following description and accompanying drawings, while the scope of the invention is set forth in the appended claims:

FIG. 1 is an exemplary block diagram of the sequential steps carried out in accordance with an embodiment of the present invention;

FIG. 2 is an exemplary vector diagram useful in understanding how the nearest neighbors of any target customer is identified in accordance with an embodiment of the invention;

FIG. 3 is an exemplary block diagram of the embodiment of FIG. 1 as implemented for the sales of frozen foods; and

FIG. 4 is an exemplary block diagram of computer apparatus that may be used to carry out the methodology of the present invention.

### DETAILED DESCRIPTION

For purposes of this patent application, the term “products” shall hereinafter mean products and/or services. In addition, the notion of “sales” Includes any form of product transfer from a product seller or offeror to a product purchaser or offeree wherein the purchaser acquires the right to use or consume a product in exchange for some consideration given to the seller by the purchaser. This benefit to the seller is generally in the form of money, but can take other non-monetary forms. Accordingly, the notion of sales and purchases includes, includes all forms of product transfers including but not limited to all forms of sales, leases, barters, or the like.

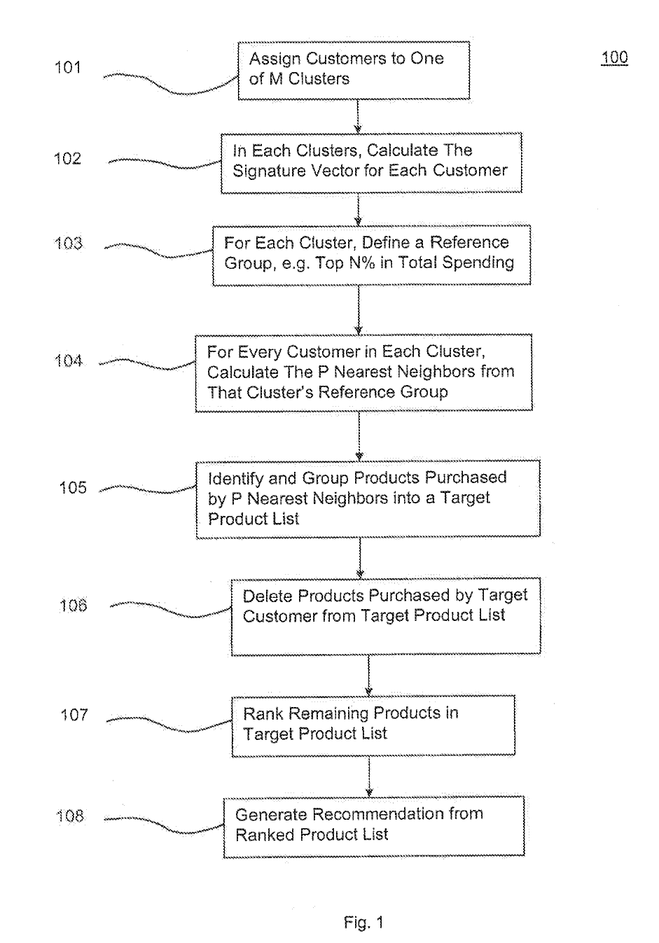

An illustrative embodiment of the present invention will be described with respect to a seller having a representative customer database maintained on a computer. The representative database includes stored information related to previous products purchases for each customer and may also include demographic information for each customer. It is also assumed that the seller offers products spanning a number of different product categories. Finally, in the embodiment of FIG. 1, each customer in the customer database is a target customer and, as will be described, a recommendation for each customer will be provided by an analysis of the data for each customer. It should, of course, be understood that the present invention is not limited to providing a recommendation for each customer and, instead, can provide a recommendation for any desired subset of customers or an individual customer included in the customer database.

FIG. 1 depicts an exemplary flow diagram 100 that illustrates representative steps for carrying out the improved recommendation method of the present invention. In FIG. 1. the method 100 begins with step 101, wherein each customer in a seller's customer database is assigned to one of M clusters, where M is an integer. The assignment of each customer to a cluster in the embodiment of FIG. 1 is based on an analysis of a number of predetermined customer attributes. The attributes used include one or more behavioral characteristics, such as the volume of prior purchases made by each purchaser from the seller during a predetermined prior time period. Optionally, the attributes used for clustering may include one or more demographic characteristics about each purchaser, such as age, urbanicity, household income, or whether or not the customer has children.

Further, one suitable method for carrying out the assignment of customers to a cluster is by a “K means” clustering, a clustering method well known in the art. A detailed description of K means clustering is provided in, for example, T. Hastie, R. Tishirani, and J. Friedman, The Elements of Statistical Learning, section 14.3.6, pages 461-463 (Springer 2001) and R. Duda, P. Hart, and D. Stork, Pattern Classification, section 10.4.3, pages 526-528 (John Wiley & Sons 2001) which publications are both incorporated in their entirety by reference herein. Other techniques may likewise be used for clustering customers in the database including, for example, Kohonen self-organizing feature maps which is described in, for example, the previously referenced Pattern Classification, at section 10.14.1, pages 576-579 (John Wiley & Sons 2001).

After the customers in the database are assigned to respective clusters in step 101, the method 100 forms, a signature vector for each customer in step 102. An exemplary signature vector possesses S dimensions, wherein each of such S dimensions represents purchasing information for a different category of products offered by the seller. For example, a suitable signature vector may comprise respective percentage values representing purchase amounts for each product category. More specifically, the value of each of the S dimensions for any customer is determined by accumulating the money spent by that customer in each of the S product categories within a predetermined prior time period, e.g., six months or the prior year. This predetermined prior time period may be the same or different from the predetermined time period used for clustering. The money spent in each product category by a customer is then converted into a corresponding percentage value for each of the product categories so that the sum of the percentage values equals 100%. Table 1 below illustrates this process for an illustrative customer of a seller that sells products in four product categories and the customer purchased various dollars amounts in each of these product categories.

Table 1 shows the dollars spent in the predetermined prior time period in each of the four different product categories—meat, frozen foods, baked goods, vegetables, and fruits—and how the percentage value is calculated for each category. Pursuant to the present invention the signature vector for this customer for the four product categories would be a four dimensional vector wherein the magnitude of the four dimensions are 60.50, 12.60, 13.80, and 13.10, respectively. In the illustrative embodiment of the invention, the total of these percentage values equals 100%. However, in accordance with the invention, it is alternatively possible to use other alternative representative values instead of the percentage values, including for example, to use a square root of the percentage such that a square of the vector sums is 1.

TABLE 1

| | | Percentage Value |
|---|---|---|
| Product Category | Dollars Spent | Category $ Spent//Total $ Spent |
| Meat | 1,800.00 | 1800/2975 = 60.50 |
| Baked Goods | 375.00 | 375/2975 = 12.60 |
| Vegetables | 410.00 | 410/2975 = 13.80 |
| Fruits | 390.00 | 390/2975 = 13.10 |
| Total $ Spent | 2,975.00 | Sum of Percentage Values = 100 |

The method 100 then defines a reference group for each of the M clusters in step 103. The reference group for each cluster includes those customers in that cluster that are within some predetermined top percentage in total purchases for the seller during the predetermined time period. In step 103, the predetermined top percentage is designated as N %. Preferred values for N % may be in the range of, for example, approximately 85% to 99.9%, however, other percentage values for N % may be utilized in accordance with the invention.

Then, in step 104, the P nearest neighbors for each customer are determined, where P is an integer. The P nearest neighbors for each customer are selected from the reference group of the cluster to which that customer has been assigned. As will be described below, the P nearest neighbors are selected from this reference group using, for example, a cosine measure. Cosine measure is a well known technique in the art for determining the proximity of respective vectors. For determining the relative proximity of two S dimensional vectors using a cosine measure, we begin with the two S dimensional vectors, designated as “a” and “b” and apply the principle that the dot product of these vectors, a·b, is given by:

$$a \cdot b = {\sum }_{i = 1}^{s} {a}_{1} {b}_{1} + {a}_{2} {b}_{2} + {a}_{3} {b}_{3} … {a}_{s} {b}_{s} \qquad ( 1 )$$

In Euclidean geometry, the dot product, vector length and angle are related. Specifically, for vectors a and b, the dot product a·b is given by:

a·b=lallbl cos Θ (2)

wherein lal and lbl respectively represent the length of vectors a and b and Θ is the angle between vectors a and b. In equation (2),

lal=\sqrt{a·a} and lbl=\sqrt{b·b} (3)

The cosine measure used in the disclosed embodiment is equation (2) expressed in terms of cos Θ, i.e.,

cos Θ=a·b/lallbl (4)

wherein vectors a and b are each a multi-dimensional vector and in this illustrative embodiment of the invention, the number of dimensions is S and each of these dimensions represents a different category of products sold by the seller.

The P nearest neighbors for a target customer determined by the cosine measure are those customers whose signature vectors are most nearly aligned with the signature vector of the target customer. That is, the P nearest neighbors determined by the cosine measure are the P customers from the reference group whose signature vectors form an angle Θ with the target customer's signature vector that is closest to 0 degrees compared to the signature vectors of the other customers in the reference group relative to the target customer. Or, equivalently, the P nearest neighbors determined by the cosine measure are those P customers in the reference group for whom the cos Θ is closest to the value 1.

Accordingly, in the previously described embodiment of the invention, the value of the integer P may be determined based on those P customers in the reference group for whom the cos Θ is greater than, for example, 0.9 or 0.95, depending upon the number and quality of the product suggestions that is produced. Alternatively, it is possible to employ a fixed value for the integer P instead determining the integer P based on the cos Θ of the nearest neighbors. Suitable fixed values for P in accordance with the invention include, for example, integer between 5 and 12 for the described frozen food recommendation system.

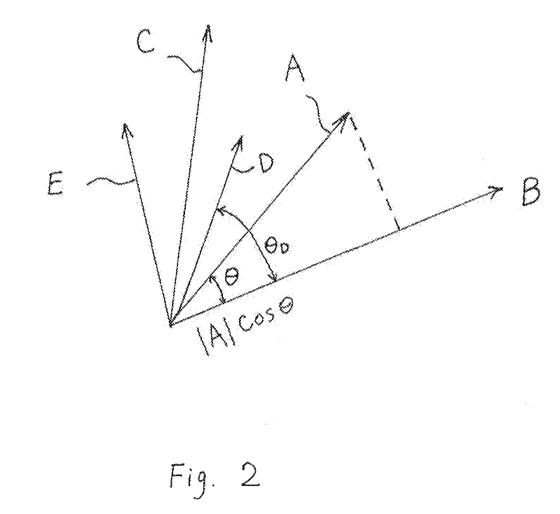

FIG. 2 illustrates an exemplary vector representation useful in understanding the application of cosine measure utilized with the present invention. In FIG. 2, two dimensional vectors A, B, C, D and E are shown. Assume for purposes of illustration that vectors A, B, C, D and E each represents the signature vector of a respective customer. Further, assume that vector B is the signature vector of the target customer and such target customer is in a cluster having a reference group in which there are four customers respectively represented by signature vectors A, C, D and E. For this exemplary vector representation, further assume that P=2. That is, we are looking for the 2 nearest neighbors. In FIG. 2, that nearest neighbor would be the customer associated with signature vector A because this signature vector and the target customer's signature vector B forms the angle Θ closest to zero degrees compared to the angle formed between signature vector B and any of the other signature vectors C, D or E. Or, equivalently, the cos Θ for vectors B and A is closest to 1. Similarly, the signature vector D is the second closest to the target customer's signature vector B forms the angle Θ_{D} that is second closest to zero degrees compared to the angle formed between signature vector B and any of the other signature vectors C or E. Or, equivalently, the cos Θ_{D} for vectors B and D is second closest to 1. Accordingly, the use of the cos measure selects the P, where P is any integer, nearest neighbors whose signature vectors form the smallest angle Θ with the signature vector of the target customer.

Now, returning to step 104 in FIG. 1, the P nearest neighbors of each target customer is determined by using equation (4). Specifically, the value of cos Θ is determined for the angle Θ formed by the signature vector of each target customer and the signature vector of each member of that target customer's reference group. The resulting cos Θs are then ranked in order of values with the P customers in the reference group whose cos Θs are closest to a value of 1 being selected as the nearest neighbors for that target customer.

Upon determination of the nearest neighbors in step 104, the method 100 proceeds to step 105 where the products purchased by the P nearest neighbors of the target customer are identified and corresponding product information is used for forming a target product list. Then, at step 106, the products in the target product list formed in step 105 are compared to those products previously purchased by the target customer in the predetermined time period and those products in the target product list have been previously purchased by the target customer are deleted or identified as excluded in the target product list. The remaining products in the target product list for the P nearest neighbors are then ranked by step 107. Various ranking methods are useable for this purpose. One suitable ranking method assigns a value (V) for each of the remaining product wherein V is given by:

$$V = {\sum }_{i} \sqrt{Cos ( i ) \times freq ( i , prod )} \times {[ 1 - perc ( cat ) ]}^{2} \qquad ( 5 )$$

wherein i is the index of the neighbor and runs from 1 to P, cos(i) is the cosine measure between the target customer and its I^{th} neighbor, freq(i,prod) is the number of purchases of product “prod” made by neighbor i, and perc(cat) is the spending percentage on the product category associated with product prod made by the target customer. The summation part of equation (1) captures the weighted frequency of purchases made by the P nearest neighbors. The square root depresses the number of purchases made by a single neighbor and prefers more neighbors' participation. The (1−perc)² factor shifts the recommendation that will be provided to the product categories that the target customer has not previously participated in heavily.
Other suitable ranking methods for use in step 107 of method 100 include dollar-based weighting of the products purchased by the nearest neighbors, and seasonal weighting factors for seasonal products such that, for example, summer products will not be recommended during the winter months.

In practice, it has been found that the disclosed embodiment will provide a recommendation for any target customer. It is rare that all the products bought by the P nearest neighbors were also bought by the target customer. Thus, in step 108, a product or products recommendation for the target customer is formed from the resulting ranking of the products in the target product list produced by step 107. Numerous methods for selecting the product based on the ranked products are useable in accordance with the present invention. One exemplary method includes generating a recommendation based on the highest ranked products in the list or based on the highest or high rated product that has also been identified as a surplus or high profit margin product by the seller.

It should be clear to one skilled in the art that steps 101 and 103 of the recommendation method 100 in FIG. 1 may be considered optional steps. Specifically, in lieu of forming clusters in step 101, each of the attributes used to assign each customer to a cluster can be added values or dimensions to the signature vector formed for each customer. If we assume that X attributes are used to assign customers to clusters, in lieu of forming an S dimension signature vector for each customer as described above, the dimensions of this signature vector could be S+X. The cosine measure can then be determined to the resulting S+X dimensional signature vectors.

In addition, while the use of the reference group in step 103 is desirable as it selects nearest neighbors from those customers in a top percentage of purchasing customers, the use of the reference group can be eliminated. If so, then the P nearest neighbors for a target customer can be determined by calculating cos Θ for the signature vector of a target customer and the signature vector of each of the other customers in the customer database, ranking the resulting cos Θs, and then selecting the P nearest neighbors whose cos Θs are closest to 1 as is described with respect to step 104. Finally, the use of equation (5), is desirable for ranking products, other ranking algorithms may also be used.

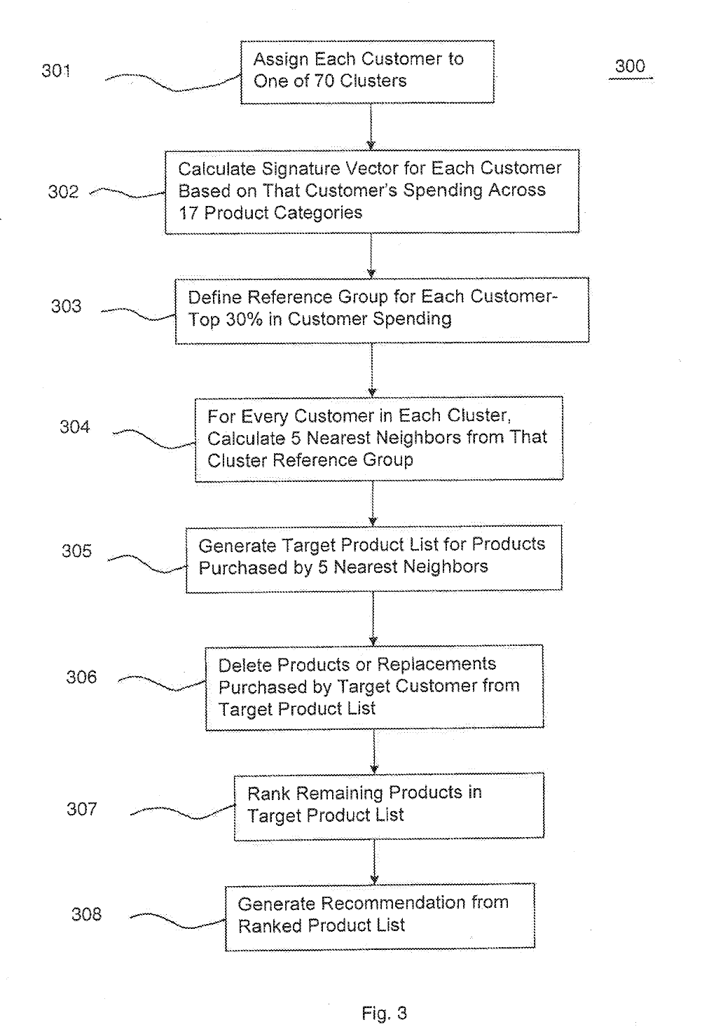

, FIG. 3 depicts an exemplary computer implemented method 300 in accordance with the present invention to provide recommendations for customers of a seller that offers, for example, a number of different categories of frozen foods. In accordance with the method 300, at step 301, each customer in the seller's computer database is assigned to one of, for example, 70 clusters based on predetermined demographic and purchasing behavior characteristics. As is previously described with respect to the method 100 of FIG. 1, K means clustering is useable to form such cluster, however, other clustering techniques are likewise useable in accordance with the present invention. Then, at step 302, the signature vector of each customer in each cluster is calculated based on the customer's past spending for the past year over, for example, 17 different product categories. Accordingly, the number of dimensions of the signature vector determined in accordance with the method 300 is 17. The value of each of the 17 signature vector dimensions for a customer is determined by accumulating the money spent during the past year by that customer in each of the 17 product categories and then converting this amount to a dollar percentile, wherein the sum of the dollar percentiles for any customer is 100%.

Then, at step 303, a reference group is determined for each cluster. This reference group includes those customers in each cluster that are in the top, for example, 30^{th} percentile in total spending during the past year. At step 304, the five nearest neighbors are determined for respective target customers in a cluster. For each of explanation, we will assume that every customer in a cluster is a target customer. Accordingly, for every target customer in each cluster, the five nearest neighbors in that cluster are determined for that target customer using the cosine measure of the 17-dimensional signature vectors.

Once the five nearest neighbors of a target customer are determined by step 304, the method 300 determines a target product list for each target customer in step 305 based on all of the products purchased by that target customer's 5 nearest neighbors. It is advantageous for the target product list to include replacements or equivalents of products no longer offered by seller. Correspondingly, all products in a product family are considered replacements for any other product in that family. However, certain frozen food products, such as, for example, items in the ice-cream, novelties or pizza categories may be handled separately and have no equivalents or replacements.

Then, at step 306, those products, equivalents or its replacements in the target product list that have been purchased by the target customer in the past year are removed or designated as excluded. At step 307, each of the products purchased by the 5 nearest neighbors remaining in the target product list after step 306, is ranked based on, for example, a calculated value (V) using equation (5) above wherein i=5. Correspondingly, in the final step 308, a product recommendation is made for each, target customer that is, for example, the highest ranked product in the ranked target product list for that target customer's 5 nearest neighbors.

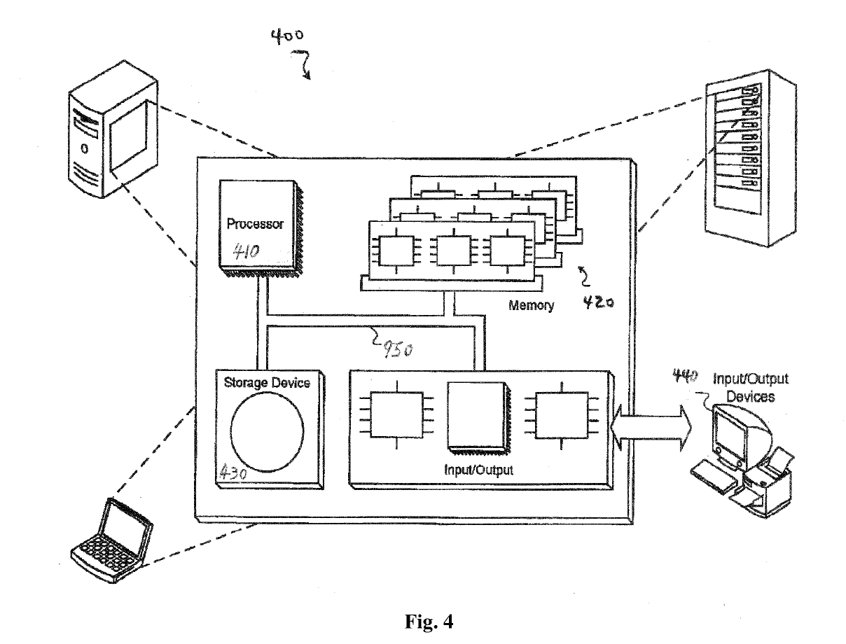

FIG. 4 depicts an illustrative computer system 400 suitable for implementing the present invention. Computer system 400 includes processor 410, memory 420, storage device 430 and input/output devices 440. Some or all of the components 410, 420, 430 and 440 may be interconnected by a system bus 950. Processor 410 may be single or multi-threaded and may have one or more cores. Processor 410 executes instructions which in the disclosed embodiments of the present invention include the steps described and shown in FIGS. 1 and 3. These instructions are stored in memory 420 or in storage device 430. Information may be received and output using one or input/output devices 440.

Memory 420 may store information and may be a computer-readable medium, such as volatile or non-volatile memory. Storage device 430 may provide storage for system 400 and may be a computer-readable medium. In various aspects, storage device 430 is suitable for maintaining the customer database and, for example, may be a flash memory device, a floppy disk drive, a hard disk device, and optical disk device, or a tape device.

Input devices 440 may provide input/output operations for system 400. Input/output devices 440 may include a keyboard, pointing device, and microphone. Input/output devices 440 may further include a display unit for displaying graphical user interfaces, a speaker and a printer. As shown the computer system 400 may be implemented in a desktop computer, or in a laptop computer, or in a server. The recommendations provided pursuant to the present invention can be provided on a computer display proximate to the computer system 900 or remote from such system and communicated wirelessly to a sales person's mobile communication device. In this manner, the recommendation can be personally presented to the target customer when such customer is visited by the seller's sales person. Alternatively, the recommendations for each target customer can be provided in mass to the seller for redistribution to the appropriate sales person that interacts with that target customer.

It should of course, be understood that while the present invention has been described with respect to disclosed embodiments, numerous variations are possible without departing from the spirit and scope of the present invention. First, for example, while sales during the past year are used for the formation of the signature vectors, sales in other prior time periods may be used. Second, while a recommendation for each customer in the seller's database is provided pursuant to the disclosed embodiment, recommendations can be provided for only certain customers in the customer database. Finally, while recommendations in the disclosed embodiments are customers, the term customer may be an individual, a group of individuals, such as a family a club ort social group or a company.

1. A computer-implemented method of recommending one or more products offered by a seller to an existing target customer of that seller, said method comprising the steps of
identifying, with respect to the target customer, at least one similar customer of the seller whose spending attributes approximate that of the target customer,
identifying the products purchased by each similar customer that have not been purchased by the target customer during a predetermined time interval,
ranking the identified products based on at least one factor, and
providing a product recommendation for the target customer that includes at least one product from the ranked identified products.

2. The method of claim 1 wherein the step of ranking the identified products is based on the total purchase price of each of the identified products.

3. The method of claim 1 wherein the step of identifying at least one similar customer also examines demographic attributes and the similar customer identified and the target customer have at least one matching demographic attribute.

4. The method of claim 1 wherein the step of identifying at least one similar customer determines a multi-dimensional vector for the target customer and for a plurality of other customers of the seller, and then examines the determined multi-dimensional vectors.

5. The method of claim 4 wherein the products offered by the seller extend over at least S different product categories and each multi-dimensional vector has S dimensions.

6. The method of claim 5 wherein each vector dimension is associated with a different one of the S product categories.

7. The method of claim 6 wherein each dimension of the determined multi-dimensional vectors has a magnitude wherein the magnitude of each dimension of the target customers multi-dimensional vector corresponds to the spending of the target customer in the product category associated with that dimension and the magnitude of each dimension of each similar customers multi-dimensional vector corresponds to the spending of that similar customer in the product category associated with that dimension.

8. The method of claim 7 wherein the identified similar customer is determined by examining the angle formed by the multi-dimensional vector of the target customer and the multi-dimensional vector of each of the other customers in the plurality.

9. The method of claim 8 wherein the identified similar customer has a multi-dimensional vector that forms an angle with the vector of the target customer that is closest to zero compared to angle formed between the target customer vector and each customer in the plurality.

10. The method of claim 8 wherein the identified similar customer has a multi-dimensional vector that forms an angle with the vector of the target customer, this angle having a cosine that is closest to one compared to the cosine of each angle formed between the target customer vector and each of the other customers in the plurality.

11. The method of claim 1 wherein the ranking of identified products determines a value V for each of the identified products.

12. The method of claim 11 wherein P similar customers are identified, where P is an integer, and wherein
$$V = {\sum }_{i} \sqrt{Cos ( i ) \times freq ( i , prod )} \times {[ 1 - perc ( cat ) ]}^{2}$$
and wherein i is the index of the similar customer and runs from 1 to P, a predetermined integer, cos(i) is the cosine measure between the customer and its i^{th} similar customer, freq(i,prod) is the number of purchases of product “prod” made by similar customer i, and perc(cat) is the spending percentage on the product category associated with product prod made by the target customer.

13. The method of claim 1 wherein the factor used for ranking includes one that indicates whether each product that is ranked is a surplus product.

14. The method of claim wherein the factor for ranking includes one that indicates whether each product that is ranked is a high profit margin product.

15. A computer-implemented method of providing a product recommendation for a target customer, the product recommendation being with respect to products of a seller that extend over a plurality of product types and the target customer being an existing customer of the seller, said method comprising the steps of
assigning the target customer and each of a plurality of other existing customers of the seller to one of a plurality of clusters based on their respective spending attributes with respect to the seller, the cluster to which the target customer, is assigned also including first customers,
forming a reference group for the cluster to which the target customer has been assigned, said reference group comprising those first customers that are within the top N % of spending with respect to the seller in a predetermined time period and wherein N is a predetermined percentage,
determining a signature vector for the target customer and for each customer in the reference group, each signature vector having S dimensions wherein each of the S dimensions represents a different category of products sold by the seller and wherein the magnitude of each dimension of the vector of the target customer corresponds to the target customer's spending in the product category corresponding to that dimension and the magnitude of each dimension of the vector of each customer in the reference group corresponds to that customer's spending in the product category corresponding to that dimension,
determining P nearest neighbors for the target customer, wherein P is an integer, by processing the signature vectors that have been formed,
identifying the products purchased by each of the P nearest neighbors that have not been purchased by the target customer,
ranking the identified products using a ranking algorithm, and
providing a product recommendation for the target customer from the ranked identified products, the recommendation including at least one of the ranked identified products.

16. The method of claim 15 wherein the assigning step uses K means clustering.

17. The method of claim 15 wherein determining the P nearest neighbors involves a determination of the angle between the signature vector of the target customer and the signature vector of each customer in the reference group.

18. The method of claim 17 wherein the P nearest neighbors are the P customers in the reference group for whom the determined angle is closest to zero.

19. The method of claim 15 wherein determining the P nearest neighbors involves a determination of the cosine of the angle between the signature vector of the target customer and the signature vector of each customer in the reference group.

20. The method of claim 19 wherein the P nearest neighbors are the P customers in the reference group for whom the determined cosine is closest to one.

21. The method of claim 18 wherein ranking of the identified products determines a value V for each of the identified products wherein
$$V = {\sum }_{i} \sqrt{Cos ( i ) \times freq ( i , prod )} \times {[ 1 - perc ( cat ) ]}^{2}$$
and wherein i is the index of the nearest neighbor and runs from 1 to P, an integer, cos(i) is the cosine measure between the customer and its i^{th} nearest neighbor, freq(i,prod) is the number of purchases of product “prod” made by nearest neighbor i, and perc(cat) is the spending percentage on the product category associated with product prod made by the target customer.

22. The method of claim 21 wherein the value P is a fixed integer.

23. The method of claim 20 wherein ranking of the identified products determines a value V for each of the identified products wherein
$$V = {\sum }_{i} \sqrt{Cos ( i ) \times freq ( i , prod )} \times {[ 1 - perc ( cat ) ]}^{2}$$
and wherein i is the index of the nearest neighbor and runs from 1 to P, a predetermined integer, cos(i) is the cosine measure between the customer and its i^{th} nearest neighbor, freq(i,prod) is the number of purchases of product “prod” made by nearest neighbor i, and perc(cat) is the spending percentage on the product category associated with product prod made by the target customer.
